(19) United States
(12) Patent Application Publication
(10) Pub. No.: US 2026/0356444 A1
(43) Pub. Date: Nov. 12, 2026

(54) Bracket

(71) Applicant: Precision Planting LLC, Tremont, IL (US)

(72) Inventor: Tracy Leman, Tremont, IL (US)

(21) Appl. No.: 19/139,260

(22) PCT Filed: Nov. 30, 2023
(86) PCT No.: PCT/IB2023/062081

§ 371 Date: Jun. 13, 2025

Related U.S. Application Data
(60) Provisional application No. 63/387,714, filed on Dec. 16, 2022.
(60) Provisional application No. 63/387,745, filed on Dec. 16, 2022.
(60) Provisional application No. 63/387,749, filed on Dec. 16, 2022.

(51) Int. Cl. B62D 49/06

(52) U.S. Cl. CPC B62D 49/0628

(57) ABSTRACT

A bracket assembly having a bracket; a base connected to the bracket; and a pair of fasteners configured to connect the base to a handle of a suitcase weight.

### CROSS-REFERENCE TO RELATED APPLICATIONS

This application claims priority to U.S. Application No. 63/387,714, filed 2022 Dec. 16; 63/387,745, filed 2022 Dec. 16; and 63/387,749, filed 2022 Dec. 16, all of which are incorporated herein by reference in their entireties.

### FIELD

Embodiments of the present disclosure relate generally to a bracket.

### BACKGROUND

Vehicles, such as tractors, can have a suitcase weight system for adding weights to the vehicle in the front or rear of the vehicle. These suitcase weight systems are typically the furthest forward or furthest rear portion of the vehicle. The suitcase weight system can be a place to mount an instrument.

### BRIEF SUMMARY

A bracket assembly having a bracket; an upper clamp configured to engage with an upper lip of a suitcase weight bar; and a lower clamp configured to engage with a cavity in the suitcase weight bar.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 is a perspective view of a suitcase weight bar and bracket assembly of a first embodiment.

FIG. 2 a top perspective view of the weight bar of FIG. 1.

FIG. 3 is a bottom perspective view of the weight bar of FIG. 1.

FIG. 4 is a perspective view of the bracket assembly of FIG. 1.

FIG. 5 is a side elevation view of the bracket assembly of FIG. 4.

FIG. 6 is a perspective view of a bracket.

FIG. 7 is a perspective view of a bracket.

FIG. 8 is a perspective view of clamps.

FIG. 9 is a side elevation view of the claims of FIG. 8.

FIG. 10 is a perspective view of a suitcase weight bar and bracket assembly of a second embodiment.

FIG. 11 is a side elevation view of the suitcase weight bar and bracket of FIG. 10.

FIG. 12 is a perspective view of the suitcase weights of FIG. 10.

FIG. 13 is a side elevation view of the bracket assembly of FIG. 10.

FIG. 14 is a perspective view of the bracket assembly of FIG. 13.

FIG. 15 is a perspective view of a suitcase weight bar and bracket assembly of a third embodiment.

FIG. 16 is a front perspective view of the suitcase weight bar of FIG. 15.

FIG. 17 is a perspective view of the bracket assembly of FIG. 15.

FIG. 18 is a side elevation view of the bracket assembly of FIG. 17.

FIG. 19 is a perspective view of a pair of bracket assemblies of FIG. 4 connected with a tie bracket.

FIG. 20 is a side elevation view of the second embodiment from FIG. 11 with an alternative first mounting bracket and second mounting bracket.

FIG. 21 is a perspective view of the first mounting bracket, second mounting bracket, and instrument of FIG. 20.

FIG. 22 is a perspective view of the first mounting bracket and second mounting bracket from FIG. 21.

FIG. 23 is a perspective view of the second mounting bracket and optional support bracket of FIG. 22.

### DETAILED DESCRIPTION

All references cited herein are incorporated herein in their entireties. If there is a conflict between definitions herein and in an incorporated reference, the definition herein shall control.

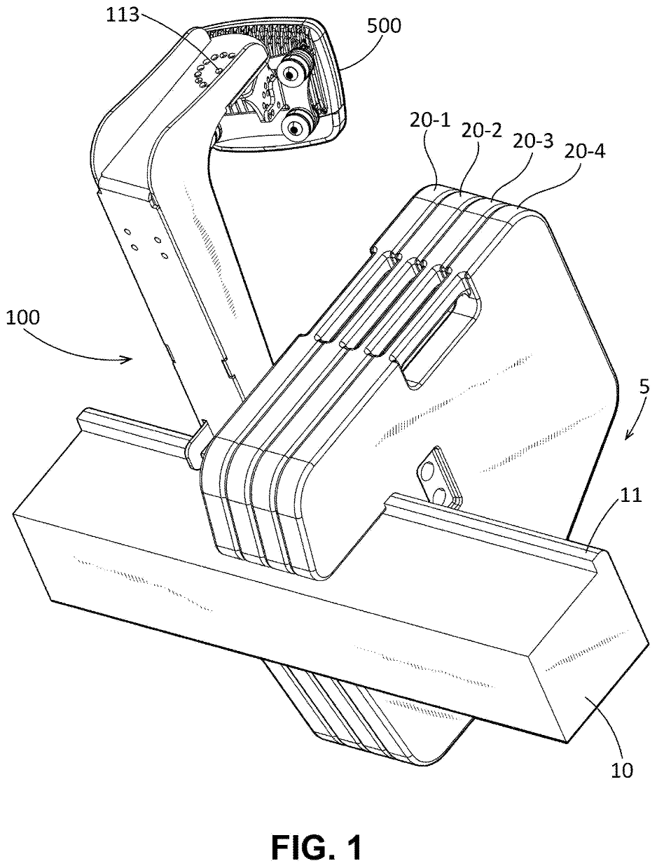

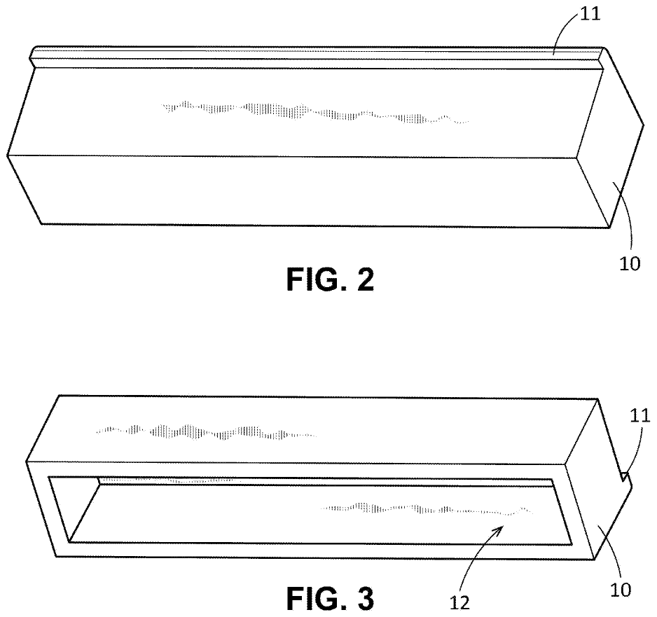

FIGS. 1-3 illustrate a particular suitcase weight system 5 having a suitcase weight bar 10 and optionally one or more suitcase weights 20 (20-1 to 20-4). Suitcase weights 20 do not need to be included. Suitcase weight bar 10 has an upper lip 11 and a cavity 12 inside the suitcase weight bar 10. Cavity 12 is opposite upper lip 11.

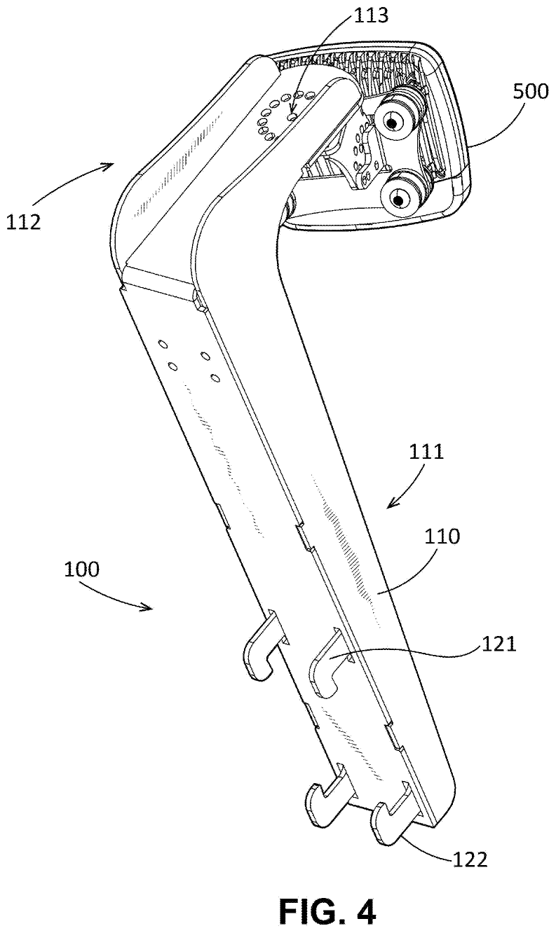

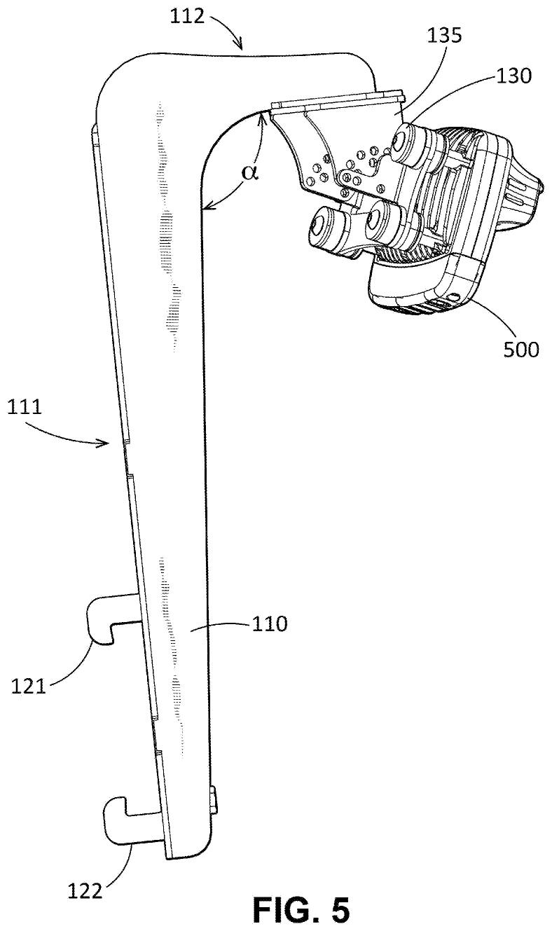

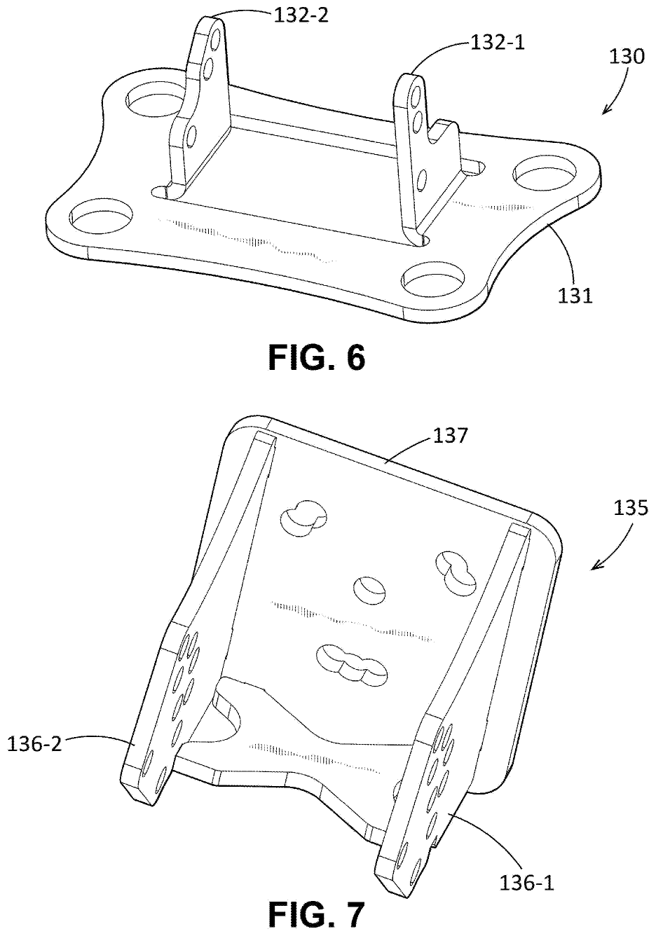

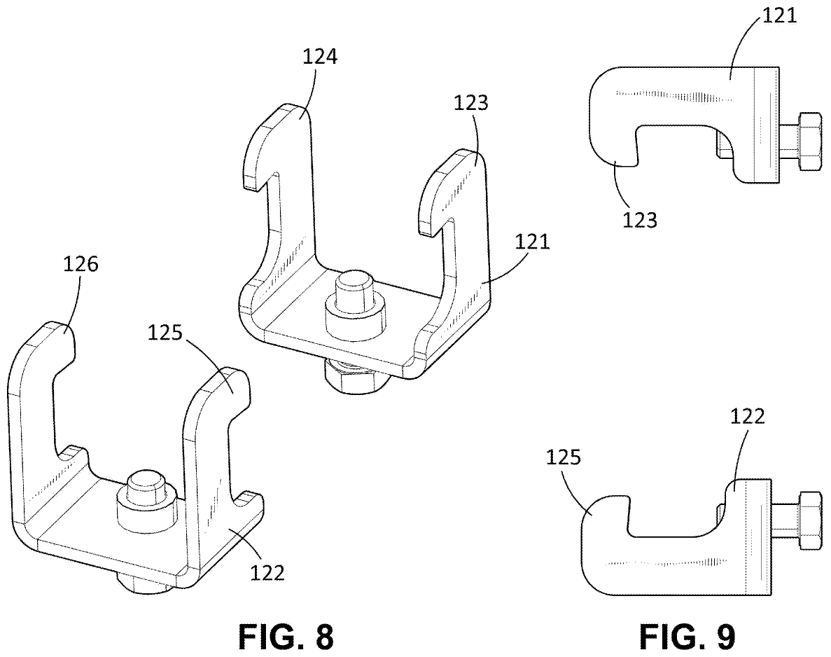

Bracket assembly 100 of FIGS. 1-9 connects to suitcase weight bar 10. Bracket assembly 100 has a bracket 110 and an upper clamp 121 that engages with upper lip 11 and lower clamp 122 that engages with cavity 12. As seen in FIGS. 8-9, upper clamp 121 and lower clamp 122 can be U-shaped and have fingers 123, 124 and 125, 126, respectively. Fingers 123, 124 engage with upper lip 11, and fingers 125, 126 engage with cavity 12.

Bracket 110 can have a first portion 111 and a second portion 112. Second portion 112 can be angled with respect to first portion 111 at an angle α. Angle α can be greater than 0° to less than 180°. In other embodiments, angle α can be 45° to 135° or about 90°.

An instrument 500 can be connected to bracket 110. Instrument 500 can be any instrument used to measure or collect measurements. In one embodiment, instrument 500 is a camera.

A first mounting bracket 135 can be rotatably connected to second portion 112 through connection 113. First mounting bracket 135 can have a face 137 for rotatable engagement with connection 113 and first side 136-1 and second side 136-2 extending perpendicularly away from face 137. Instrument 500 can be connected to second mounting bracket 130.

A second mounting bracket 130 can be connected to first mounting bracket 135, optionally rotatably connected. Second mounting bracket 130 can have a face 131, which can connect with instrument 500. Extending perpendicularly away from face 131 are first side 132-1 and second side 132-2. First side 132-1 can engage with first side 136-1, and second side 132-2 can engage with second side 136-2.

With rotatable engagements, instrument 500 can be oriented at any desired direction.

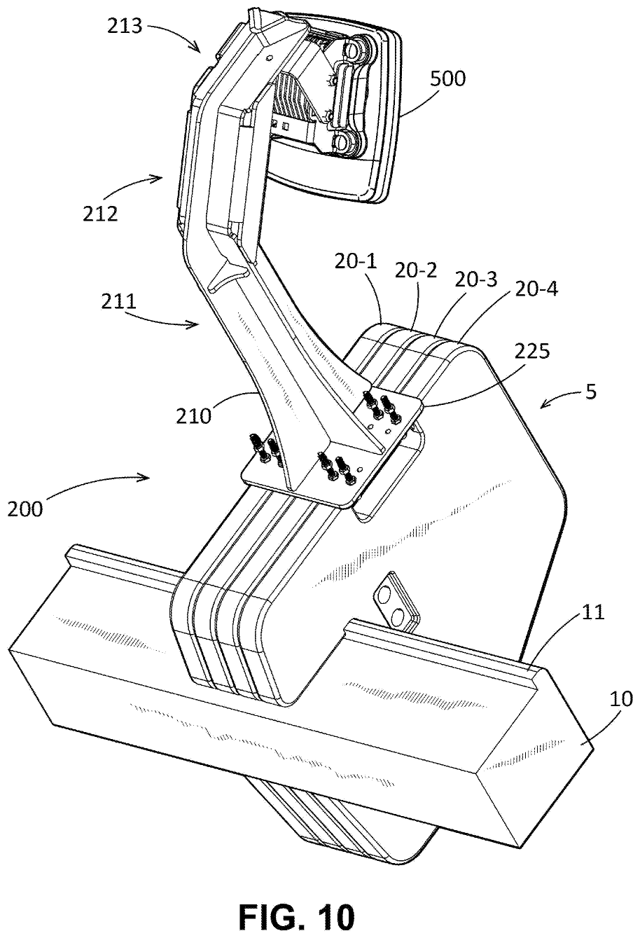

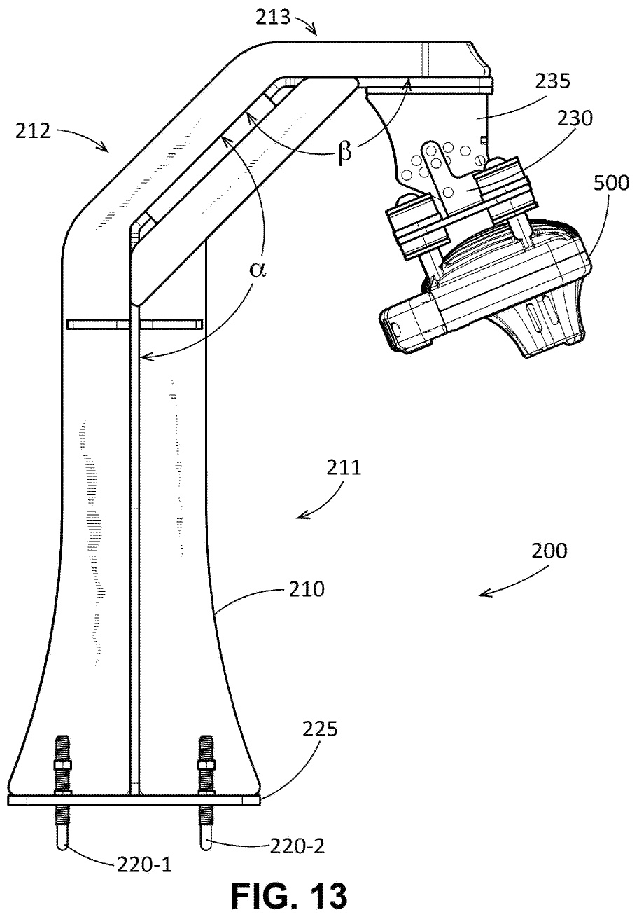

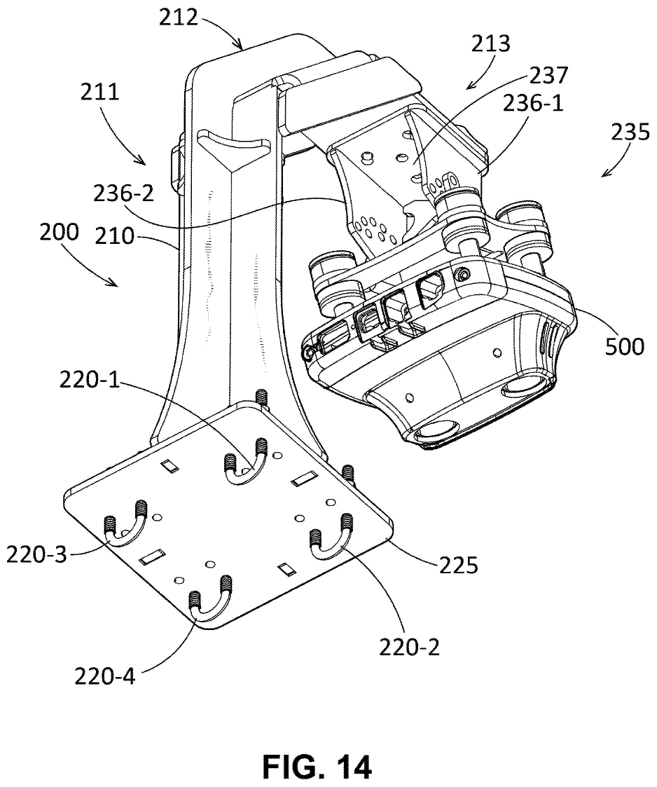

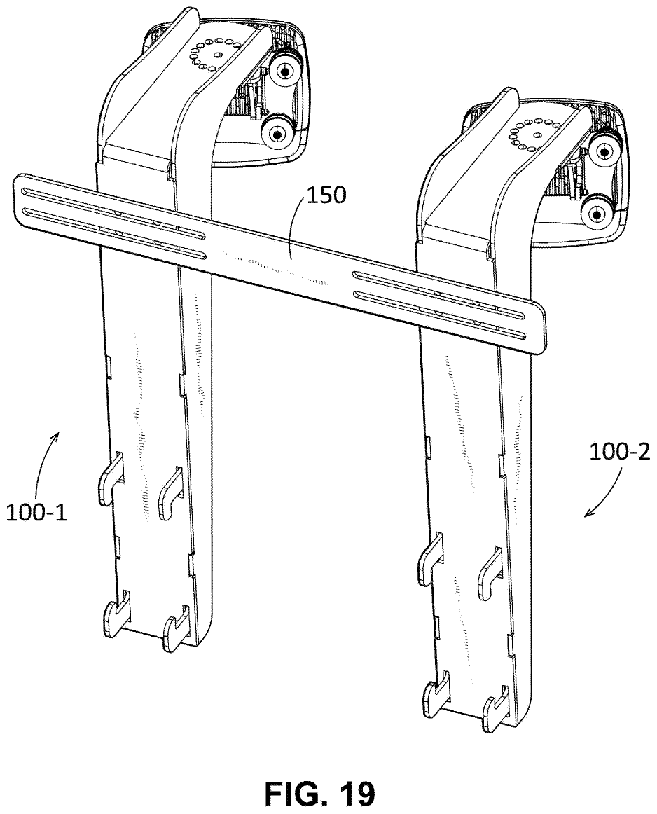

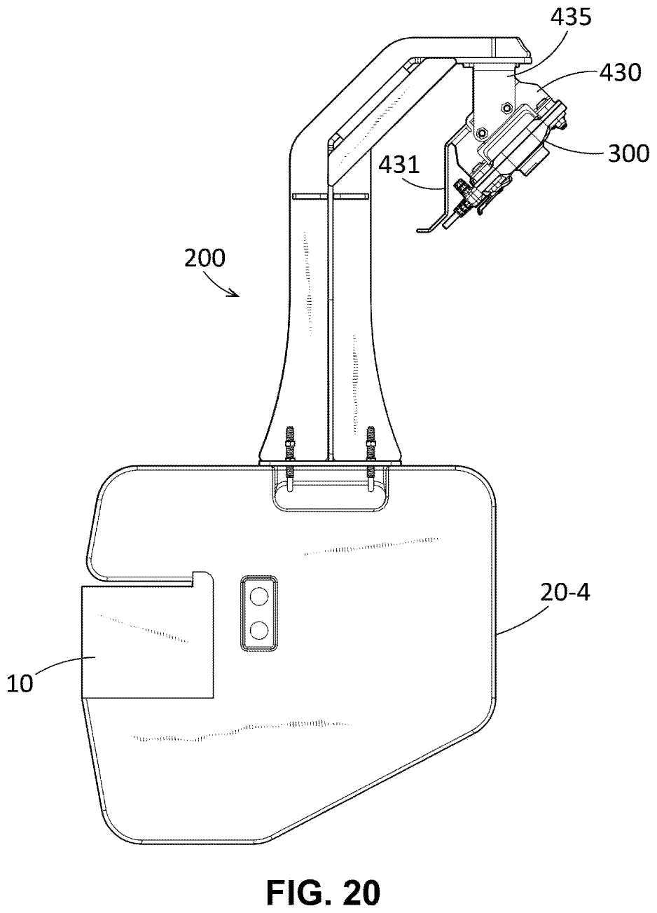

In another embodiment as illustrated in FIG. 19, there can be multiple bracket assemblies 100 (100-1, 100-2) on suitcase weight bar 10, and they can be connected together with tie bracket 150 FIGS. 10-14 illustrate bracket assembly 200. A weight system 5 has a suitcase weight bar 10 and one or more suitcase weights 20 (20-1 to 20-4). Suitcase weight bar 10 has an upper lip 11 but does not need cavity 12.

Bracket assembly 200 has a bracket 210 and a base 225. Bracket 210 can have more than one portion. As illustrated, bracket 210 has a first portion 211, a second portion 212, and a third portion 213. Second portion 212 can be angled with respect to first portion 211 at an angle α. Angle αcan be greater than 0° to less than 180°. In other embodiments, angle α can be 45° to 135° or about 90°. Third portion 213 can be angled with respect to second portion 212 at an angle β. Angle β can be greater than 0° to less than 180°. In other embodiments, angle β can be 45° to 135° or about 90°.

A first mounting bracket 235 can be connected to third portion 213, optionally rotatably connected. First mounting bracket 235 can be the same as first mounting bracket 135. First mounting bracket 235 can have a face 237 for rotatable engagement with third portion 213 and first side 236-1 and second side 236-2 extending perpendicularly away from face 237.

A second mounting bracket 230 can be connected to first mounting bracket 235, optionally rotatably connected. Second mounting bracket 230 can be the same as second mounting bracket 130. Instrument 500 can be connected to second mounting bracket 230.

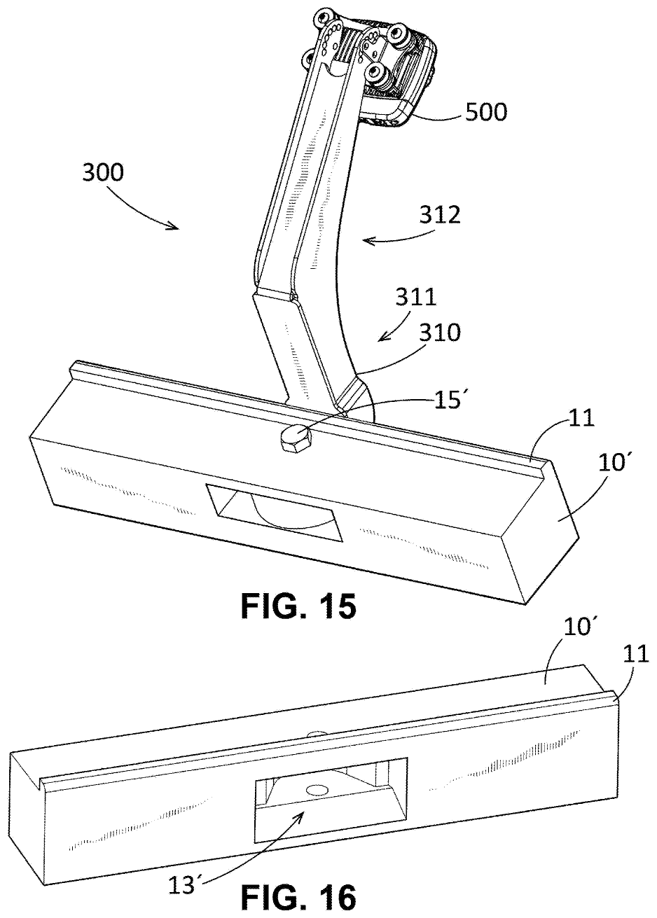

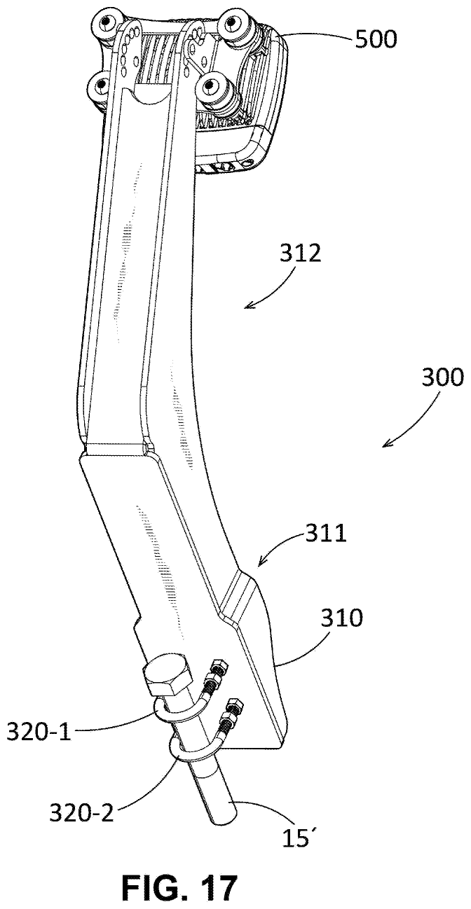

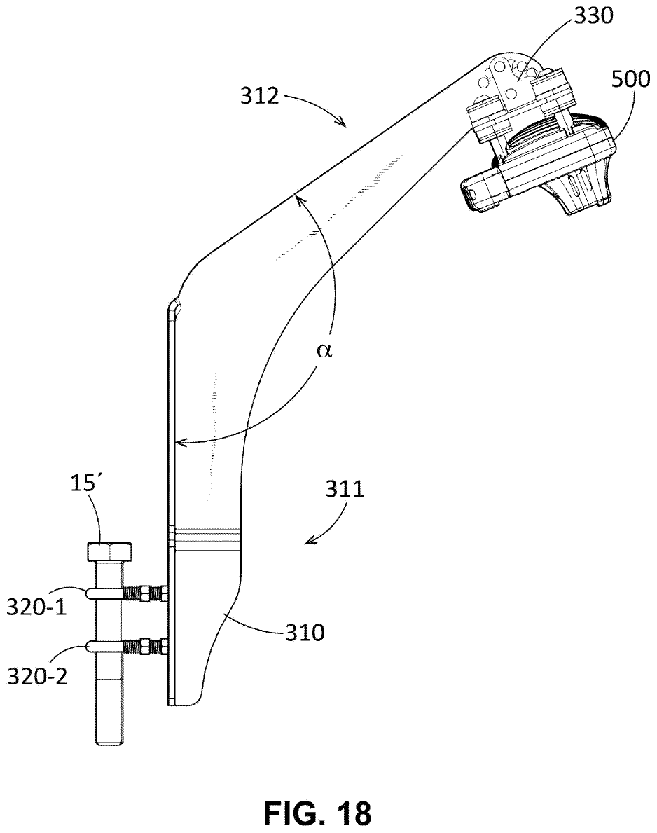

FIGS. 15-18 illustrate bracket assembly 300, which can connect to suitcase weight bar 10′, which can have a lip 11. Suitcase weight bar 10′ has a cavity 13′ with a shaft 15′ extending transversely through cavity 13′.

Bracket assembly 300 has a bracket 310. Bracket 310 can have more than one portion. As illustrated, bracket 310 has a first portion 311 and a second portion 312. Second portion 312 can be angled with respect to first portion 311 at an angle α. Angle α can be greater than 0° to less than 180°. In other embodiments, angle α can be 45° to 135° or about 90°. At least one U-bolt 320 is connected to bracket 310. In one embodiment, there is a pair of U-bolts 320-1, 320-2. Cavity 13′ is configured to receive U-bolts 320 (320-1, 320-2) with shaft 15′ extending through U-bolts 320 (320-1, 320-2) to retain bracket assembly 300 to suitcase weight bar 10′.

Second mounting bracket 330 can be connected to second portion 312, optionally rotatably connected. Second mounting bracket 330 can be the same as second mounting bracket 130. Instrument 500 can be connected to second mounting bracket 330.

First mounting bracket 135 and second mounting bracket 130 from bracket assembly 100 can be used in bracket assembly 200 or bracket assembly 300. First mounting bracket 235 and second mounting bracket 230 from bracket assembly 200 can be used in bracket assembly 100 or bracket assembly 300. Second mounting bracket 330 from bracket assembly 300 can be used in bracket assembly 100 or bracket assembly 200.

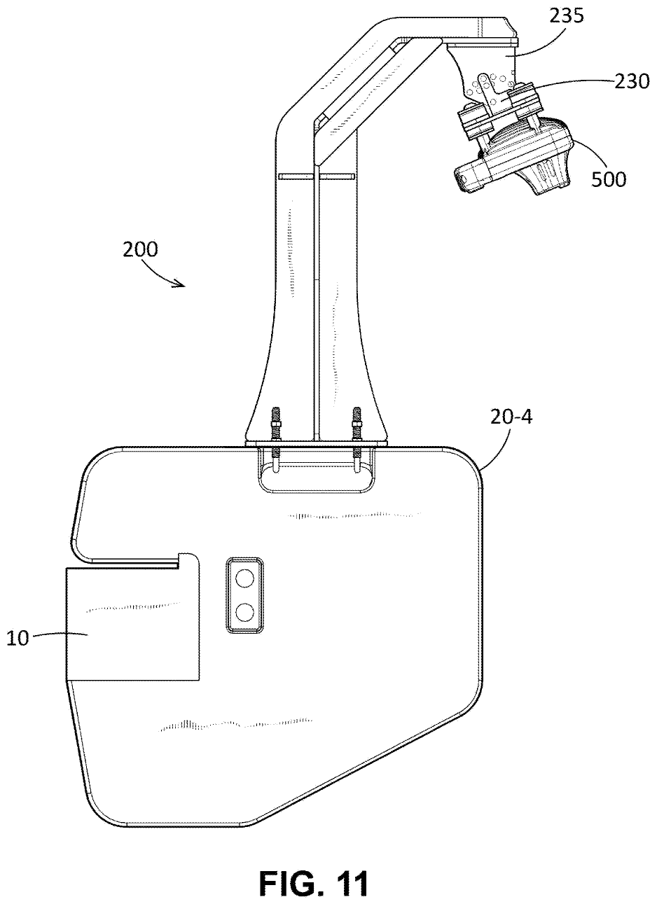

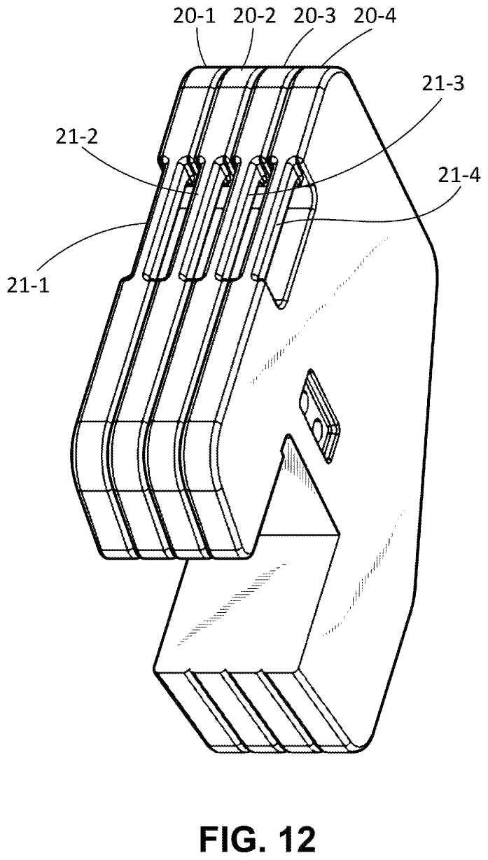

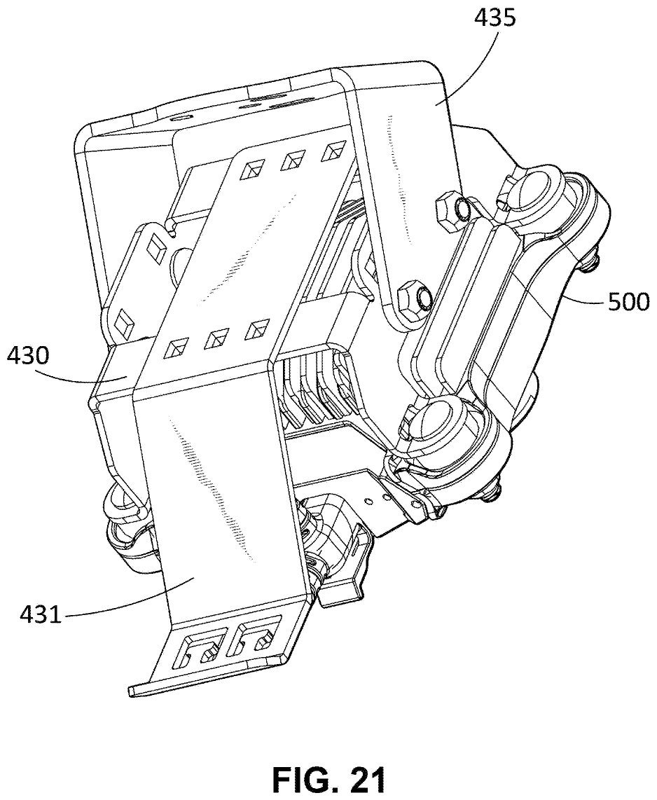

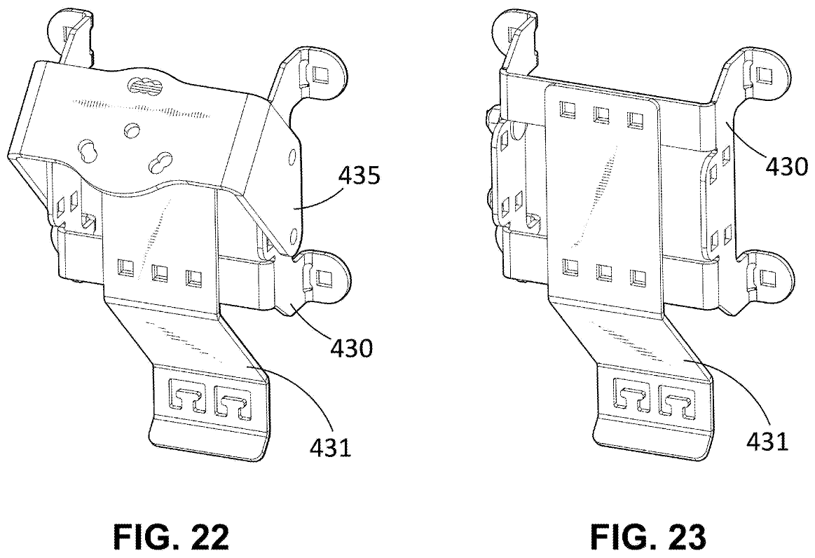

FIGS. 21 to 23 illustrate an alternative first mounting bracket 435 and second mounting bracket 430 disposed on the second embodiment from FIG. 11. First mounting bracket 435 can be used in place of any of first mounting brackets 135, 235, or 335. Second mounting bracket 430 can be used in place of any of the second mounting brackets 130, 230, or 330. Optionally, a support bracket 431 can be connected to second mounting bracket 430 opposite to instrument 500. Support bracket 431 can add protection to instrument 500 or any components thereof, such as cables.

### EXAMPLES

The following are nonlimiting examples.
Example 1—a bracket assembly comprising: a bracket; an upper clamp configured to engage with an upper lip of a suitcase weight bar; and a lower clamp configured to engage with a cavity in the suitcase weight bar.
Example 2—the bracket assembly of Example 1, wherein the bracket has a first portion and a second portion angled with respect to the first portion.
Example 3—the bracket assembly of Example 2, wherein the second portion further comprises a first mounting bracket connected to the second portion.
Example 4—the bracket assembly of Example 3, wherein the first mounting bracket is rotatably connected to the second portion.
Example 5—the bracket assembly of Example 3 or 4 further comprising a second mounting bracket rotatably connected to the first mounting bracket.
Example 6—the bracket assembly of Example 5, wherein the second mounting bracket is rotatably connected to the first mounting bracket.
Example 7—the bracket assembly of Example 5 or 6 further comprising an instrument connected to the second mounting bracket.
Example 8—the bracket assembly of any one of Examples 5 to 7 further comprising a support bracket connected to the second mounting bracket.
Example 9—the bracket assembly of any preceding Example, wherein the upper clamp is U-shaped and comprises a pair of fingers that engage with the upper lip.
Example 10—the bracket assembly of any preceding Example, wherein the lower clamp is U-shaped and comprises a pair of fingers that engage with the cavity.
Example 11—a bracket assembly comprising: a bracket; a base connected to the bracket; and a pair of fasteners configured to connect the base to a handle of a suitcase weight.
Example 12—the bracket assembly of Example 11, wherein the bracket has a first portion and a second portion angled with respect to the first portion.
Example 13—the bracket assembly of Example 12 further comprising a third portion angled with respect to the second portion.
Example 14—the bracket assembly of Example 13, wherein the third portion further comprises a first mounting bracket connected to the third portion.
Example 15—the bracket assembly of Example 14, wherein the first mounting bracket is rotatably connected to the third portion.
Example 16—the bracket assembly of Example 14 or 15 further comprising a second mounting bracket connected to the first mounting bracket.
Example 17—the bracket assembly of Example 16, wherein the second mounting bracket is rotatably connected to the first mounting bracket.
Example 18—the bracket assembly of Example 16 or 17 further comprising an instrument connected to the second mounting bracket.
Example 19—the bracket assembly of any one of Examples 16 to 18 further comprising a support bracket connected to the second mounting bracket
Example 20—the bracket assembly of any of Examples 11-19 further comprising a second pair of fasteners configured to connect the base to a handle of a second suitcase weight.
Example 21—the bracket assembly of Example 20 further comprising a third pair of fasteners configured to connect the base to a handle of a third suitcase weight and a fourth pair of fasteners configured to connect the base to a handle of a fourth suitcase weight.
Example 22—the bracket assembly of any of Examples 11-21, wherein the fastener is a U-bolt.
Example 23—a bracket assembly comprising: a bracket; at least one U-bolt connected to the bracket; a suitcase weight bar having a cavity configured to receive the at least one U-bolt; and a shaft extending transversely through the cavity and the U-bolt.
Example 24—the bracket assembly of Example 23, wherein there is a pair of U-bolts connected to the bracket.
Example 25—the bracket assembly of Example 23 or 24, wherein the bracket has a first portion and a second portion angled with respect to the first portion.
Example 26—the bracket assembly of Example 25 further comprising a second mounting bracket connected to the second portion.
Example 27—the bracket assembly of Example 26, wherein the second mounting bracket is rotatably connected to the first portion.
Example 28—the bracket assembly of Example 26 or 27 further comprising an instrument connected to the second mounting bracket.
Example 29—the bracket assembly of any of Example 26 to 28 further comprising a support bracket connected to the second mounting bracket.

1. A bracket assembly comprising:
a bracket;
a base connected to the bracket; and
a pair of fasteners configured to connect the base to a handle of a suitcase weight.

2. The bracket assembly of claim 1, wherein the bracket has a first portion and a second portion angled with respect to the first portion.

3. The bracket assembly of claim 2 further comprising a third portion angled with respect to the second portion.

4. The bracket assembly of claim 3, wherein the third portion further comprises a first mounting bracket connected to the third portion.

5. The bracket assembly of claim 4, wherein the first mounting bracket is rotatably connected to the third portion.

6. The bracket assembly of claim 4 further comprising a second mounting bracket connected to the first mounting bracket.

7. The bracket assembly of claim 6, wherein the second mounting bracket is rotatably connected to the first mounting bracket.

8. The bracket assembly of claim 6 further comprising an instrument connected to the second mounting bracket.

9. The bracket assembly of claim 1 further comprising a second pair of fasteners configured to connect the base to a handle of a second suitcase weight.

10. The bracket assembly of claim 9 further comprising a third pair of fasteners configured to connect the base to a handle of a third suitcase weight and a fourth pair of fasteners configured to connect the base to a handle of a fourth suitcase weight.

11. The bracket assembly of claim 1, wherein the fastener is a U-bolt.
